(19) United States
(12) Patent Application Publication
(10) Pub. No.: US 2016/0067022 A1
(43) Pub. Date: Mar. 10, 2016

(54) Oral Care System

(71) Applicant: Renée J. JETTON, Sheridan, OR (US)

(72) Inventor: Renée J. JETTON, Sheridan, OR (US)

(21) Appl. No.: 14/482,281

(22) Filed: Sep. 10, 2014

(51) Int. Cl. A61C 17/06; A61H 13/00; A61C 17/22

(52) U.S. Cl. CPC A61C 17/046; A61C 17/228; A61H 13/00

(57) ABSTRACT

An oral-care system includes a tooth shroud, vacuum hose and a vacuum pump to apply suction to a user's teeth and gums, disrupting the growth of bacterial colonies there. Disrupting and/or removing bacteria can help protect teeth and dental prosthetics, and may be effective to prevent halitosis and systemic diseases that are related to oral flora.

### CONTINUITY AND CLAIM OF PRIORITY

This is an original U.S. patent application.

### FIELD

The invention relates to devices and systems for the treatment of either natural or artificial teeth. More specifically, the invention relates to oral-care apparatus including a nozzle at which a low pressure is created to draw air or material through or around a nozzle.

### BACKGROUND

The mouth, teeth and gums are an important and sensitive area of the body, with surprisingly diverse and significant relationships to other bodily systems and to overall health. Tools, equipment, materials and techniques for promoting dental hygiene have improved continually over the years, but new relationships between oral and overall health are regularly discovered, and new threats to oral health are recognized.

Current products and services address oral-care needs ranging from the purely cosmetic to the medically necessary, and the aggregate industry size is substantial. Thus, new techniques and apparatus to improve oral care may have significant benefits both in terms of patient-health outcomes and in economic value.

### SUMMARY

Embodiments of the invention are oral-care systems that facilitate the focused application of vacuum or suction and tactile stimulation to portions of the mouth, teeth and/or gums. Embodiments can also be used for cleaning, care and maintenance of dental prosthetics such as dentures.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a general representation of the components included in an embodiment.

FIG. 2 is a graph of two example pressure profiles that may be used by embodiments.

FIG. 3 shows several views and details of a mouthpiece according to one embodiment.

FIG. 4 shows an alternate mouthpiece embodiment.

FIG. 5 shows another alternate mouthpiece embodiment.

### DETAILED DESCRIPTION

Embodiments of the invention are oral-care systems suitable for home or professional/medical use. They facilitate the application of negative pressure (vacuum, suction) over portions of a user's (or patient's) teeth and gums. Many implementations apply pulsed or variable-strength suction to the areas treated, and the mouthpiece may be configured to provide a mechanical stimulation or massage function as well as the vacuum application. Application of suction and massage may be effective to disrupt bacterial colony growth at the treated sites.

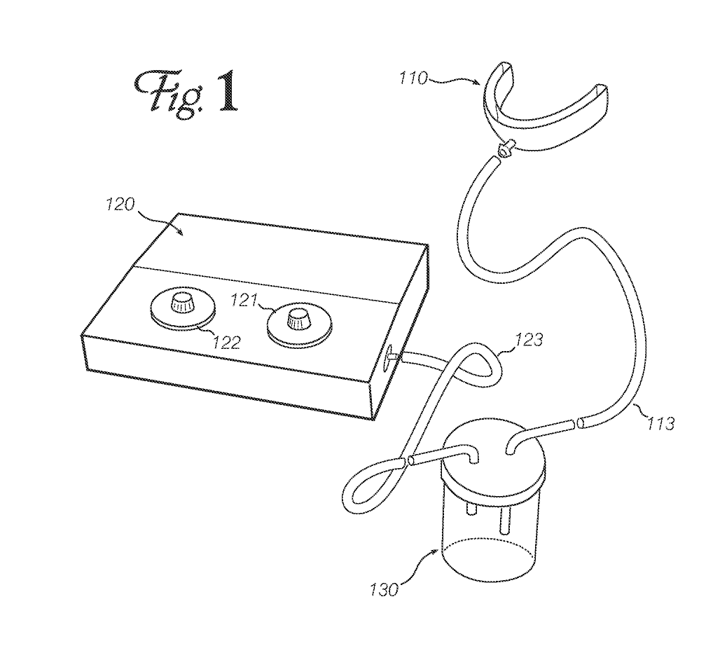

FIG. 1 shows components of a representative embodiment. Element 110 is a horseshoe-shaped mouthpiece which is placed at the location to be treated (e.g., over a user's teeth and gums, the gums alone [if the user has removed his dental prosthetics], over a dental prosthetic that has been removed from the mouth for care and cleaning, or over dentures while they are still in the mouth). The mouthpiece is in fluid communication with a vacuum pump 120, the suction being transmitted to mouthpiece 110 by vacuum tubes 113 and 123. In many embodiments, a liquid exclusion device 130 is placed between the mouthpiece 110 and pump 120 to prevent liquid from traveling from the mouthpiece 110 and into the pump 120.

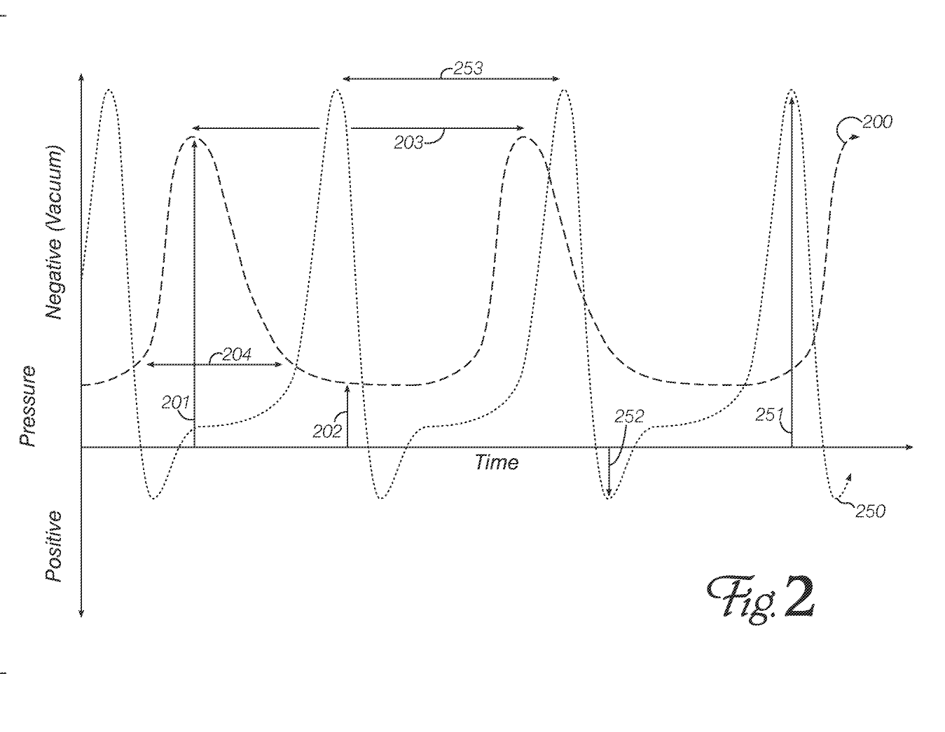

Pump 120 may be electrically operated, and may have user adjustments 121, 122 to alter the vacuum strength and variable-suction characteristics such as the duty cycle, period, and pressure profile. These characteristics are shown in the graph of FIG. 2, which depicts two sample operational modes of the vacuum pump of an embodiment. The graph relates pressure versus time. A first trace 200 (long clashes) shows a first pump setting, where the pressure cycles between a relatively high value 201 and a more moderate value 202. The period of this cycle is 203, and the duty cycle is 204. In contrast, a second pump setting is shown by trace 250 (short clashes). This setting has an even higher maximum vacuum 251, but its relaxed or minimum pressure is actually positive, 252 (i.e., greater than ambient or atmospheric pressure). Thus, in this mode, the pump would both draw air and/or fluid towards itself from the mouthpiece, and expel or return the air or fluid during the positive-pressure portion of the cycle. The second setting has a slightly shorter period 253 than the first setting, so the pressure profile repeats or cycles more rapidly. Some pumps may offer a random or variable-period, variable-strength and/or variable-duty-cycle setting. Most embodiments will use pumps with a maximum vacuum capacity of around 350 mm Hg (mercury), and a maximum positive-pressure capacity of around 100 mm Hg.

The pump and vacuum lines of an embodiment are relatively unexceptional; any commercially-available products of suitable size and pressure capability may be used. For example, an automatic dairy pump and associated suction lines may function acceptably. Connections among components may be made by mechanically interlocking fittings, hose-barb connections, or permanent (e.g., glued or ultrasonically welded) connections. It is preferred that the tubing be inexpensive (and thus easily replaceable) or easy to disassemble for cleaning and sterilization.

The optional liquid exclusion device helps protect the pump from drawing in liquid such as saliva or cleaning solution. It is preferable that the liquid exclusion device be easy to disassemble and clean. (Alternatively, the device may be a consumable supply, and configured to be easily replaced when soiled or filled.) The liquid exclusion device has an intake that carries gases (e.g., air) and liquid (e.g., water or saliva) from the mouthpiece, and an exhaust that preferentially allows only gases to continue through the device to the pump. Liquids are trapped in the exclusion device so that they are less likely to enter and damage the pump.

Mouthpieces for use with an embodiment may be constructed in a variety of forms, and from a variety of materials. The horseshoe-shaped mouthpiece of FIG. 1 is a common and useful form, suitable for applying suction to the maxillary or mandibular arch of a set of natural teeth, or to a full denture. This form has a passage from the concave area near the teeth and gums, through to a hose barb extending outside the mouthpiece. A vacuum hose of an embodiment is connected at the hose barb so that the pump can apply suction to the areas under treatment.

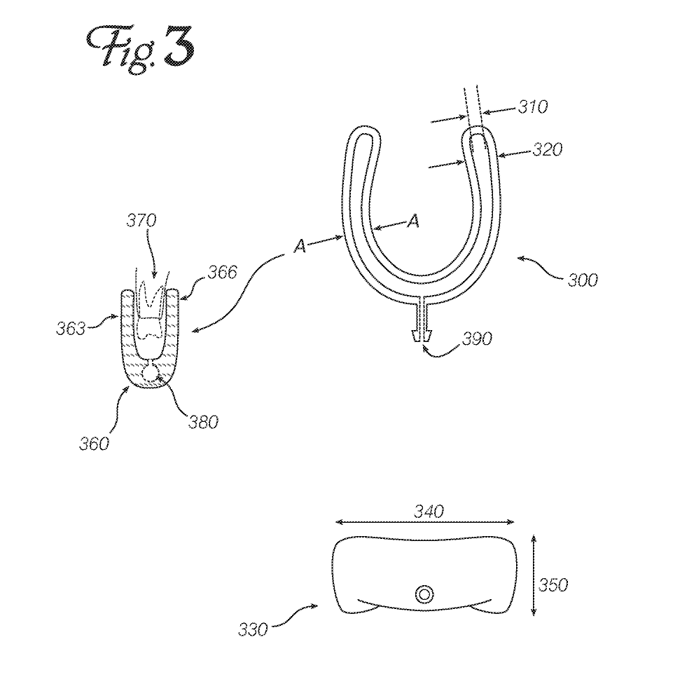

FIG. 3 shows several views and details of this common mouthpiece form. Top view 300 shows a channel with interior width 310 of, e.g., 4-5 mm. The overall width of the mouthpiece channel 320 may be, e.g., 9-13 mm. Mouthpieces may be supplied in a range of sizes, to fit corresponding patients' mouths.

A section through the channel at A-A, 360, shows how the soft, flexible channel sides 363, 366 may be positioned alongside the patient's teeth and gums, 370. A vacuum channel 380 formed in the bottom of the channel may transmit suction from the pump, via hose barb connection 390, to the treatment site near the teeth and gums. Alternatively, a single vacuum orifice just inside the channel behind the hose connection may be provided. In this arrangement, an embodiment relies on the flexibility and conformance of the channel walls to create a seal between the mouthpiece and gums so that the teeth and gums are exposed to the treatment suction.

Treatment is facilitated by manual manipulation of the mouthpiece in the mouth (or on dentures removed from the mouth). For example, the user may pinch the sides of the mouthpiece against the teeth and gums, causing the channel sides to seal against the gums. When so sealed, the vacuum pump develops suction at and around the teeth sealed into the mouthpiece channel.

Front view 330 shows the overall mouthpiece width 340, which may be about 50 mm, and the overall mouthpiece height 350, which may be about 20 mm.

FIG. 4 shows an alternate mouthpiece shape. Instead of a horseshoe to fit over a complete dental arch of a patient, this mouthpiece is a short and roughly rectangular cup 410 which can be positioned over just one or two teeth. Its width 420 and length 430 are suitable for manual manipulation within the mouth (or on dental prosthetics removed from the mouth) by a user's thumb and one or two fingers. Like the horseshoe-shaped mouthpiece of FIG. 3, this mouthpiece may be formed of silicone, polycarbonate, or a similar soft, flexible, compliant material that can seal and hold a moderate vacuum against a patient's teeth and gums. The mouthpiece comprises a vacuum-pump connection 440 through which suction is applied during treatment. As in other embodiments, a variable-strength pump may be used, or a user-controlled suction adjustment (e.g., an opening to atmospheric pressure that can be covered or exposed) allows finer control of the suction applied to the treatment area where the mouthpiece covers the teeth and gums.

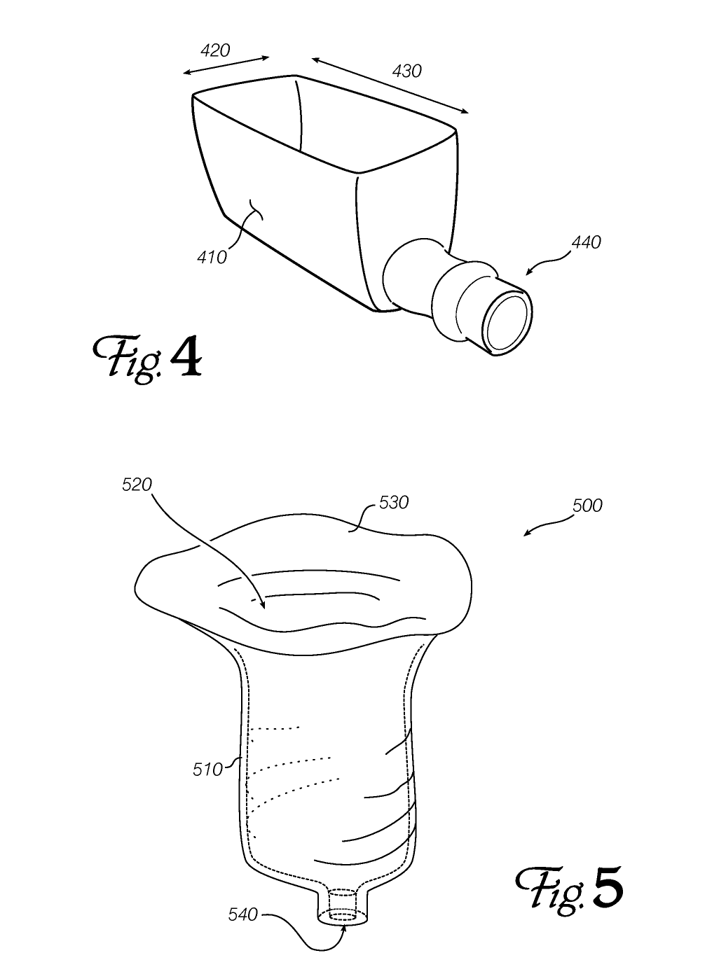

FIG. 5 is another alternate mouthpiece. This embodiment (generally 500) has an open tulip or vase shape with thin, conformable walls 510 and an open distal end 520. The open end 520 may have a flare, ruffle or flange 530 of the same material (typically, a soft, flexible, compliant and biocompatible material such as silicone, polycarbonate, or a natural material such as rubber or latex). Opposite the open end, a thicker-walled portion having a cylindrical hole 540 is sized and shaped to accept a vacuum tube which connects back to the vacuum pump. Since the whole system is operated under negative pressure, a simple friction fit between the vacuum tube and the mouthpiece at 540 may be adequate (in comparison to the hose barbs shown in other exemplary mouthpieces).

To operate the mouthpiece of FIG. 5, the user connects the vacuum system at 540 and then places the open end of the tulip shape over the tooth or gum area to be treated. The ruffle or flange may help establish a seal against the patient's tissue so that the tooth or gum area is exposed to negative pressure. The walls of this mouthpiece should be thin enough so that the vacuum pressure can draw them securely against the tooth or gum, but not so thin that they (the walls) collapse together against each other in areas where they are not directly in contact with or supported by teeth or gums.

Mouthpieces generally have a concave portion sized and shaped to fit relatively closely over and around a portion of one or more teeth or gums (or similar dental structures) to be treated. For focused treatment of a small number of teeth (or of a dental prosthetic attachment point embedded into the patient's bone and exposed within the mouth) a small, flexible shroud may be used.

Each mouthpiece has at least one vacuum connection (e.g., a hose barb or a simple friction-fit opening), to be joined to the pump by a suitable hose or tube. Outer surfaces of the mouthpiece may be textured to improve the user's grip, or may have loops or cups for securing to the user's fingers.

The mouthpiece may be cast or formed of a flexible, biocompatible material such as silicone or polycarbonate. A portion of the mouthpiece may be stiffer, while sides or “wings” may be more compliant so that they conform to and press against adjacent tooth and gum surfaces during treatment. I.e., when the pump applies suction, portions of the mouthpiece are drawn against the patient's teeth and/or gums. The suction (and preferably the pulsating or variable suction) may help disrupt bacterial growth in and around the treated areas. Some mouthpieces may be formed of a heat-moldable polymer which can be customized to a user's mouth by heating (e.g., by immersion in boiling water), then carefully holding the mouthpiece in position against the teeth and gums until it cools. Some materials may be repeatedly shaped in this manner.

Mouthpieces may include textured surfaces in areas adjacent the teeth and gums. For example, the sides or wings of a mouthpiece may have ribs, bumps or protrusions that are pressed against the teeth and gums by the force of the vacuum pump. In addition, the user may squeeze, press or agitate the mouthpiece against the teeth and gums during treatment. This may improve the function of an embodiment by mechanically disturbing bacterial colonies, as well as disrupting them through the suction function.

An embodiment may use a constant-vacuum pump, but be provided with a user-controllable port so that the effective suction applied to the treatment site can be varied. For example, a simple hole or opening in the vacuum tube, which can be partly or completely covered by the user's finger, can adjust the suction applied from the full pump vacuum (when the hole is occluded) to zero vacuum (i.e., atmospheric pressure, when the hole is uncovered).

The applications of the present invention have been described largely by reference to specific examples and in terms of particular allocations of functionality to certain device and system features. However, those of skill in the art will recognize that a variable suction treatment can also be developed and applied to a patient's teeth and/or gums by sets of components that distribute the functions of embodiments of this invention differently than herein described. Such variations and implementations are understood to be captured according to the following claims.

I claim:

1. An oral care system comprising:
a flexible shroud to cover a portion of a tooth and an adjacent gum; and
a vacuum pump in fluid communication with the flexible shroud so that the vacuum pump applies suction to the tooth and the adjacent gum when the flexible shroud is positioned over the tooth and the adjacent gum.

2. The oral care system of claim 1 wherein the vacuum pump is a variable vacuum pump, said variable vacuum pump to apply pulsating suction to the tooth and the adjacent gum.

3. The oral care system of claim 1, further comprising:
liquid exclusion means positioned between the flexible shroud and the vacuum pump to prevent liquid from traveling from the flexible shroud to an inlet of the vacuum pump.

4. The oral care system of claim 1 wherein the vacuum pump is to supply a maximum vacuum of about 350 mm Hg.

5. The oral care system of claim 1 wherein the vacuum pump is to supply a minimum vacuum of about atmospheric pressure.

6. The oral care system of claim 1 wherein the vacuum pump is to supply a maximum positive pressure of about 100 mm Hg.

7. The oral care system of claim 1 wherein fluid communication between the flexible shroud and the vacuum pump is established by a tube connecting the flexible shroud and the vacuum pump, the system further comprising:
an opening in the tube to break the suction when the opening is uncovered.

8. The oral care system of claim 7 wherein the suction may be varied between approximately atmospheric pressure and approximately a maximum vacuum developed by the vacuum pump by partially covering the opening.

9. An oral care system comprising:
a mouth piece to cover portions of a dental structure of an animal;
a vacuum hose connected to the mouth piece to evacuate spaces between the mouth piece and the dental structure of the animal; and
variable vacuum means to apply a pulsating negative pressure to the vacuum hose.

10. The oral care system of claim 9, further comprising:
a liquid trap to prevent liquid entering the vacuum hose from passing through to the variable vacuum means.

11. The oral care system of claim 9 wherein the variable vacuum means is a dairy vacuum pump.

12. The oral care system of claim 9 wherein a surface of the mouth piece adjacent the dental structure has one of a rib, a bump or a protrusion that is pressed against the dental structure when the variable vacuum means applies the pulsating negative pressure to the vacuum hose.

13. An oral care system comprising:
a horseshoe-shaped mouth piece to cover teeth and portions of gums of a patient, said mouth piece having a passage from an area near a tooth to a hose barb extending outside the mouth guard;
a liquid-exclusion device having an intake and an exhaust;
a variable vacuum pump to produce a pulsating negative pressure;
a first hose for connecting the hose barb to the intake of the liquid-exclusion device; and
a second hose for connecting the exhaust of the liquid-exclusion device to an intake of the variable vacuum pump.

14. The oral care system of claim 13 wherein the horseshoe-shaped mouth piece is formed primarily of polycarbonate.

15. The oral care system of claim 13 wherein the horseshoe-shaped mouth piece is formed primarily of silicone.

16. The oral care system of claim 13 wherein the horseshoe-shaped mouth piece is formed primarily of a heat-moldable polymer.
